(19) United States
(12) Patent Application Publication
(10) Pub. No.: US 2017/0004524 A1
(43) Pub. Date: Jan. 5, 2017

(54) Systems and Methods For Mobile Campaign Optimization Without Knowing User Identity

(71) Applicant: Yahoo! Inc., Sunnyvale, CA (US)

(72) Inventors: Lin MA, Sunnyvale, CA (US); Giovanni GARDELLI, Sunnyvale, CA (US); Gaurav DHAGE, Sunnyvale, CA (US)

(73) Assignee: YAHOO! INC., Sunnyvale, CA (US)

(21) Appl. No.: 14/788,227

(22) Filed: Jun. 30, 2015

(51) Int. Cl. G06Q 30/02

(52) U.S. Cl. CPC G06Q 30/0245; G06Q 30/0267; G06Q 30/0269

(57) ABSTRACT

Systems and methods are provided for mobile campaign optimization without knowing user identity. The system includes circuitry configured to obtain mobile application data about a mobile application from at least one mobile device. The system includes circuitry configured to generate a mobile application profile for the mobile application using the mobile application data. The system further includes circuitry configured to select at least one mobile application to show a mobile advertisement in the at least one mobile application at least partially using the mobile application profile.

### BACKGROUND

The Internet is a ubiquitous medium of communication in most parts of the world. The emergence of the Internet has opened a new forum for the creation and placement of advertisements (ads) promoting products, services, and brands. Internet content providers rely on advertising revenue to drive the production of free or low cost content. Advertisers, in turn, increasingly view Internet content portals and online publications as a critically important medium for the placement of advertisements.

Mobile advertising is a form of advertising via mobile (wireless) phones or other mobile devices. Mobile advertising are closely related to online or internet advertising, though its reach is far greater. There are different types of advertising which may include: a Mobile Web Banner (top of page), Mobile Web Poster (bottom of page banner), and Short Message Service (SMS) advertising. Other forms of mobile advertising include MMS advertising, advertising within mobile games and mobile videos, during mobile TV receipt, full-screen interstitials, which appear while a requested item of mobile content or mobile web page is loading up, and audio advertisements that can take the form of a jingle before a voicemail recording, or an audio recording played while interacting with a telephone-based service such as movie ticketing or directory assistance.

As mobile advertising becomes more and more popular, advertisers are spending more and more on mobile ads as their customers are shifting time from desktop to mobile. Comparing to advertising on web site, advertising on mobile applications faces new challenges including difficulty in tracking user activities on different mobile devices. Thus, there is a need to develop methods and systems to help advertisers to improve mobile advertising campaigns without knowing user identity.

### SUMMARY

Different from conventional solutions, the disclosed system solves the above problem by building a database including mobile application profiles based on contextual neutral performances without user identity information.

In a first aspect, the embodiments disclose a computer system that includes a processor and a non-transitory storage medium accessible to the processor. The system includes circuitry configured to obtain mobile application data about a mobile application from at least one mobile device. The system includes circuitry configured to generate a mobile application profile for the mobile application using the mobile application data. The system further includes circuitry configured to select at least one mobile application to show a mobile advertisement in the at least one mobile application at least partially using the mobile application profile.

In a second aspect, the embodiments disclose a computer implemented method by a system that includes one or more devices having a processor. In the computer implemented method, the system obtains mobile application data about a mobile application from at least one mobile device. The system generates a mobile application profile for the mobile application using the mobile application data. The system selects a first mobile application to show a mobile advertisement in the first mobile application at least partially using the mobile application profile. The system selects a second mobile application to show the mobile advertisement in the second mobile application at least partially based on a user overlap between the first mobile application and the second mobile application.

In a third aspect, the embodiments disclose a non-transitory storage medium configured to store a set of instructions. The non-transitory storage medium includes instructions executable to obtain mobile application data about a plurality of mobile applications from at least one mobile device. The non-transitory storage medium further includes instructions executable to generate a mobile application profile for each of the plurality of mobile applications using the mobile application data. The non-transitory storage medium includes instructions executable to rank the plurality of mobile applications at least partially based on corresponding mobile application profiles comprising indication of performance of mobile application on contextual neutral advertising. The non-transitory storage medium includes instructions executable to select at least one mobile application to show a mobile advertisement from the ranked plurality of mobile applications.

### BRIEF DESCRIPTION OF THE DRAWINGS

FIG. 1 is a block diagram of an example environment in which a computer system according to embodiments of the disclosure may operate;

FIG. 2 illustrates an example computing device in the computer system;

FIG. 3 illustrates an example embodiment of a server computer for managing mobile advertising campaigns;

FIG. 4 is an example block diagram illustrating embodiments of the non-transitory storage of the server computer;

FIG. 5 is an example block diagram illustrating embodiments of the non-transitory storage of the server computer;

FIG. 6 is an example flow diagram illustrating embodiments of the disclosure;

FIG. 7 is an example flow diagram illustrating embodiments of the disclosure;

FIG. 8 is an example block diagram illustrating embodiments of the disclosure; and

FIG. 9 is an example block diagram illustrating embodiments of the disclosure.

### DETAILED DESCRIPTION OF THE DRAWINGS

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The term “social network” refers generally to a network of individuals, such as acquaintances, friends, family, colleagues, or co-workers, coupled via a communications network or via a variety of sub-networks. Potentially, additional relationships may subsequently be formed as a result of social interaction via the communications network or sub-networks. A social network may be employed, for example, to identify additional connections for a variety of activities, including, but not limited to, dating, job networking, receiving or providing service referrals, content sharing, creating new associations, maintaining existing associations, identifying potential activity partners, performing or supporting commercial transactions, or the like.

A social network may include individuals with similar experiences, opinions, education levels or backgrounds. Subgroups may exist or be created according to user profiles of individuals, for example, in which a subgroup member may belong to multiple subgroups. An individual may also have multiple “1:few” associations within a social network, such as for family, college classmates, or co-workers.

An individual's social network may refer to a set of direct personal relationships or a set of indirect personal relationships. A direct personal relationship refers to a relationship for an individual in which communications may be individual to individual, such as with family members, friends, colleagues, co-workers, or the like. An indirect personal relationship refers to a relationship that may be available to an individual with another individual although no form of individual to individual communication may have taken place, such as a friend of a friend, or the like. Different privileges or permissions may be associated with relationships in a social network. A social network also may generate relationships or connections with entities other than a person, such as companies, brands, or so-called ‘virtual persons.’ An individual's social network may be represented in a variety of forms, such as visually, electronically or functionally. For example, a “social graph” or “socio-gram” may represent an entity in a social network as a node and a relationship as an edge or a link.

A mobile app may refer to a mobile application, which includes a computer program designed to run on mobile devices including smartphones, tablet computers, smart watches, and etc.

While the publisher and social networks collect more and more user data through different types of e-commerce applications, news applications, games, social networks applications, and other mobile applications on different mobile devices, a user may by tagged with different features accordingly. Using these different tagged features, online advertising providers may create more and more audience segments to meet the different targeting goals of different advertisers.

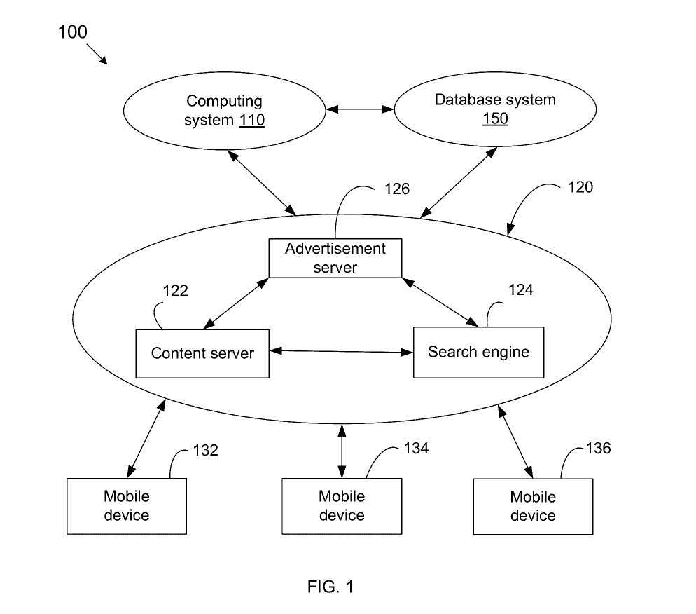

FIG. 1 is a block diagram of an environment 100 in which a computer system according to embodiments of the disclosure may operate. However, it should be appreciated that the systems and methods described below are not limited to use with the particular exemplary environment 100 shown in FIG. 1 but may be extended to a wide variety of implementations.

The environment 100 may include a computing system 110 and a connected server system 120 including a content server 122, a search engine 124, and an advertisement server 126. The computing system 110 may include a cloud computing environment or other computer servers. The server system 120 may include additional servers for additional computing or service purposes. For example, the server system 120 may include servers for social networks, online shopping sites, and any other online services.

The content server 122 may be a computer, a server, or any other computing device known in the art, or the content server 122 may be a computer program, instructions, and/or software code stored on a computer-readable storage medium that runs on a processor of a single server, a plurality of servers, or any other type of computing device known in the art. The content server 122 delivers content, such as a web page, using the Hypertext Transfer Protocol and/or other protocols. The content server 122 may also be a virtual machine running a program that delivers content.

The search engine 124 may be a computer system, one or more servers, or any other computing device known in the art, or the search engine 124 may be a computer program, instructions, and/or software code stored on a computer-readable storage medium that runs on a processor of a single server, a plurality of servers, or any other type of computing device known in the art. The search engine 124 is designed to help users find information located on the Internet or an intranet.

The advertisement server 126 may be a computer system, one or more computer servers, or any other computing device known in the art, or the advertisement server 126 may be a computer program, instructions and/or software code stored on a computer-readable storage medium that runs on a processor of a single server, a plurality of servers, or any other type of computing device known in the art. The advertisement server 126 is designed to provide digital ads to a web user based on display conditions requested by the advertiser. The advertisement server 126 may include computer servers for providing ads to different platforms and websites.

The computing system 110 and the connected server system 120 have access to a database system 150. The database system 150 may include memory such as disk memory or semiconductor memory to implement one or more databases. At least one of the databases in the database system may be a campaign database that stores information related to a plurality of campaign delivery feeds. The campaign delivery feeds may include impressions, conversions, video views, or other events performed on the marketing message. The campaign delivery feeds are generally created near real time right after the events are performed. For example, a publisher like Yahoo! may generate millions of campaign delivery feeds per minute and the data size of the campaign delivery feeds may be greater than one gigabytes during one second. Thus, it is nearly impossible for current computer system to generate a report letter without human supervision. At the same time, human supervision cannot keep up with the pace of the huge amount of campaign delivery feeds data.

At least one of the databases in the database system may be a user database that stores information related to audience feeds related to a plurality of users. The user database may be affiliated with a data provider. The amount of audience feeds data may be greater than the amount of data of the corresponding campaign delivery feeds. The audience feeds may include all information related to a specific user from different data sources including: the publisher, the advertiser, or any other third parties such as a social network. For example, the record file may include personal information of the user, search histories of the user from the search engine 124, web browsing histories of the user from the content server 122, or any other information the user agreed to share with a data provider. Because the audience feeds may be created by different publishers on different platforms, the audience feeds may be marked differently across different publishers and platforms. Thus, there is a need to develop a computer system that can identify the human understandable information from the huge amount of audience feeds data.

The environment 100 may further include a plurality of mobile devices 132, 134, and 136. The mobile devices may be a computer, a smart phone, a personal digital aid, a digital reader, a Global Positioning System (GPS) receiver, or any other device that may be used to access the Internet.

The disclosed system and method for optimizing mobile campaigns may be implemented by the computing system 110. Alternatively or additionally, the system and method for optimizing mobile campaigns may be implemented by one or more of the servers in the server system 120. The disclosed system may instruct the mobile devices 132, 134, and 136 to display one or more mobile ads in one or more mobile applications. The disclosed system may also instruct the mobile devices 132, 134, and 136 to display information related to mobile application profiles.

Generally, an advertiser or any other user may use a computing device such as mobile devices 132, 134, and 136 to access information on the server system 120 and the data in the database 150. The advertiser may want to learn the insights about mobile applications with users who may like their mobile ads or customers who may perform a preset action in response to their mobile ads. One of the technical problems solved by the disclosure is a lack of robust and reliable method to track user activities in different mobile apps. On mobile app, each app developer may have her/his own ways of tracking user activities, it is hard to keep track with what the activities mean without knowledge from the mobile app developer and no mobile app log documents.

Further, on mobile devices, different from desktops, the conventional computer system cannot track user activities by cookie mapping, or user login ID on a specific web site. On mobile devices, it becomes more complicated as no standard ways to have a user ID for each mobile app. There is no standard general browser cookie which each Http request will contain in each desktop Http request. In mobile advertising, for example, ID for advertisers (IDFA), Android ID, or MAC address may be used for user identity. However, there is no standard way to map to a specific desktop user, unless the user logins the same app on both desktop and mobile app, which is not feasible for many advertisement systems including Yahoo!.

Conventional methods tries to address the above problem by using user identity mapping to track mobile users by user profiles or by building better user segments. The disclosed solution builds a profile for each mobile app. The profile may include indication of app quality, user base properties, contextual neutral performance, and contextual information based on keywords. Thus, the disclosed computer system may recommend mobile apps to advertisers based on the profile for each mobile app.

Further, the system solves technical problems presented by managing large amounts of user data represented by different user data from each app developer. Through processing collected data, the system reduces the data size to app profiles. The system may then update the app profiles at least partially based on the user data.

The system provides a scalable solution to calculate the user overlap of any pair of mobile apps. The system further estimates performance of a mobile app based on the average performance of overlap users. The solution may then expand mobile campaign to new mobile apps based on the estimated performance.

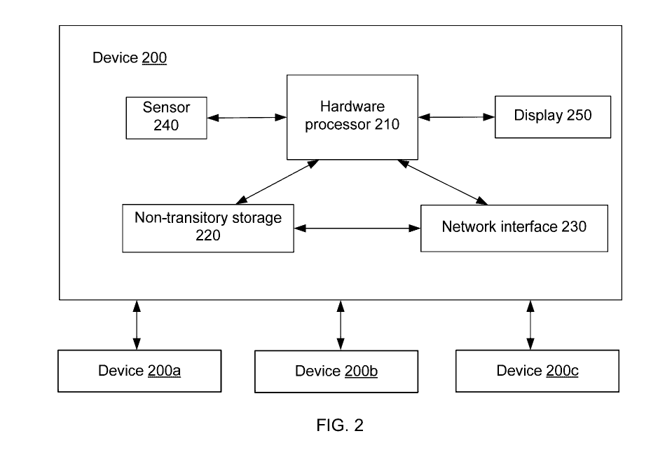

FIG. 2 illustrates an example computing device 200 for interacting with the advertiser. The computing device 200 may communicate with a computer server of the system. The computing device 200 may be a computer, a smartphone, a server, a terminal device, or any other computing device including a hardware processor 210, a non-transitory storage medium 220, and a network interface 230. The hardware processor 210 accesses the programs and data stored in the non-transitory storage medium 220. The device 200 may further include at least one sensor 240, circuits, and other electronic components. The device may communicate with other devices 200a, 200b, and 200c via the network interface 230.

The computing device 200 may display user interfaces on a display unit 250. For example, the computing device 200 may display a user interface on the display unit 250 asking the advertiser to input one or more identifications of a campaign. The user interface may provide checkboxes, dropdown selections or other types of graphical user interfaces for the advertiser to select geographical information, demographical information, mobile application information, technology information, publisher information, or other information related to an online campaign.

The computing device 200 may further display the app profiles. The computing device 200 may also display one or more drawings or figures that have different formats such as bar charts, pie charts, trend lines, area charts, etc. The drawings and figures may represent the app performances or estimated app performances.

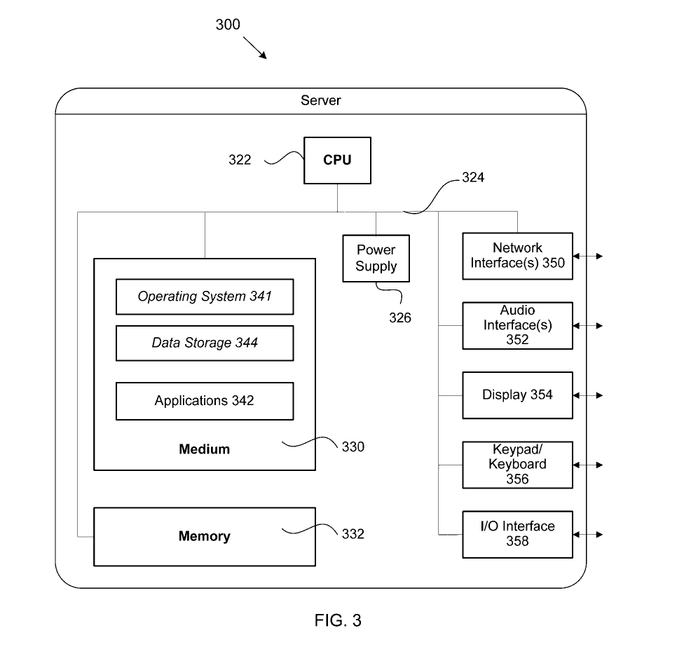

FIG. 3 is a schematic diagram illustrating an example embodiment of a server. A server 300 may include different hardware configurations or capabilities. For example, a server 300 may include one or more central processing units 322, memory 332 that is accessible to the one or more central processing units 322, one or more medium 330 (such as one or more mass storage devices) that store application programs 342 or data 344, one or more power supplies 326, one or more wired or wireless network interfaces 350, one or more input/output interfaces 358. The memory 332 may include non-transitory storage memory and transitory storage memory.

A server 300 may also include one or more operating systems 341, such as Windows Server, Mac OS X, Unix, Linux, FreeBSD, or the like. Thus, a server 300 may include, as examples, dedicated rack-mounted servers, desktop computers, laptop computers, set top boxes, integrated devices combining various features, such as two or more features of the foregoing devices, or the like.

The server 300 in FIG. 3 may serve as any computer server shown in FIG. 1. The server 300 may also serve as a computer server that implements the computer system for optimizing mobile campaigns. In either case, the server 300 is in communication with a database that stores segment data and campaign data. The segment data may include different audience segments built on search data, email data, page view data, TV data, mobile application data, social data, and etc. collected by different data providers. The campaign data may include creative landing uniform resource locator (URL), advertiser name, advertiser product, competitor information, campaign slogan, or other meta-data related to a campaign.

For example, the segment data may include at least the following data related to the underlying product or service: the age group of the audience, the income range of the audience, the geographical location of main residence, the spending range in a preset time period, the TV provider of the audience, and the number of friends in one or more social networks. These aspects may represent campaign features collected from search data, content data, email data, and social areas. The campaign data may include both history campaign data and campaign data of currently running campaigns on one or more mobile apps.

The database may further include mobile app profiles. For each mobile app, the mobile app profile may include an indication of quality of the mobile application and an indication of performance of the mobile app on contextual neutral advertising. The quality of mobile application may include app popularity measured by the number of total downloads and user ratings of the app. The quality of mobile application may further include user interactions with the app on major social networks and the number of followers of the corresponding account in major social networks.

The server 300 is programmed to obtain mobile application data about a mobile application from at least one mobile device; generate a mobile application profile for the mobile application using the mobile application data; and select at least one mobile application to show a mobile advertisement in the at least one mobile application at least partially using the mobile application profile.

For example, the server 300 may be programmed to obtain mobile application data about a mobile application from at least one mobile device in a preset time period, where the preset time period may a minute, an hour, or any other preset time period according to advertiser needs and/or server setup. The mobile application data may be first collected by a mobile application at a mobile device and then transmitted to a server computer via a network connection. The mobile application data may include mobile device identifications. In that case, the server 300 may obtain mobile device identifications using the mobile application data related to the plurality of campaigns from at least one advertiser. The mobile device identifications may be a code that is configured to conceal personal identification information of the users. For example, the code may be a pure digital code, a partially digital code, or any other code understandable by a computing device.

After receiving the mobile application data, the server 300 is programmed to generate a mobile application profile for the mobile application using the mobile application data. The server 300 may update the mobile application profile based on the mobile application data from time to time. For example, the server 300 may update the indication of quality of the mobile app when the number of total downloads changes or when the user ratings changes. Further, the server 300 may update the user base of the mobile app when a new user started using the mobile app.

After generating mobile application profiles for a plurality of mobile apps, the server 300 is programmed to select at least one mobile application to show a mobile advertisement in the at least one mobile application at least partially using the mobile application profile. The server 300 may first select one mobile application with the best performance record. For example, the server 300 may estimate the performance of the plurality of mobile apps using the indication of quality of the mobile application and the indication of performance of the mobile app on contextual neutral advertising. The server 300 may then expand the mobile campaign to a second mobile app at least partially based on the user overlap between the first mobile app and the second mobile app.

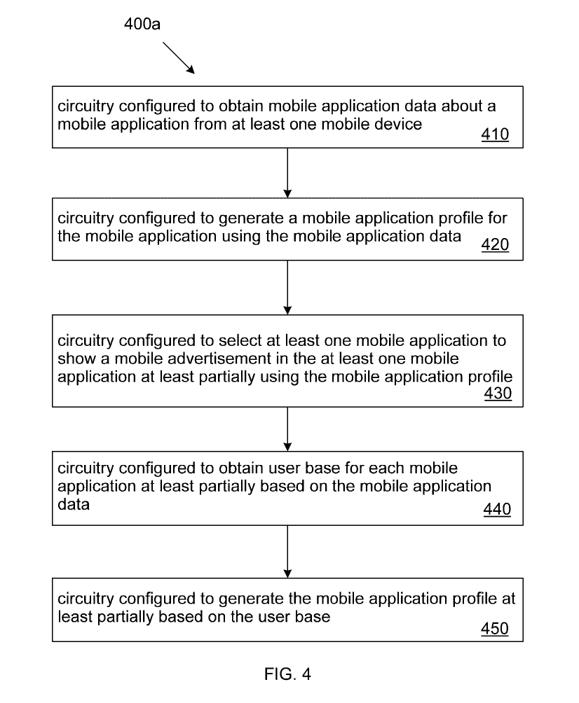

FIG. 4 illustrates embodiments of a block diagram 400a in the server 300 illustrated in FIG. 3. The block diagram 400a includes one or more circuitries. The one or more circuitries may include processors, integrated circuits, digital signal processors, or any other types of hardware, or a combination of software and hardware, for example. The block diagram 400a may include alternative, additional or fewer circuitries in other embodiments.

The block diagram 400a includes a circuitry 410 configured to obtain mobile application data about a mobile application from at least one mobile device. The circuitry 410 may obtain mobile application data by crawling app store information on different mobile operating systems including iOS®, Android®, etc. The circuitry 410 may get user ranking, download volume information, and the amount of followers and activities on major social networks from the mobile application data. An app with higher user base, and higher reputation may have higher returns for advertiser since user spending more and more time there. Accordingly, the circuitry 410 may combine the different mobile application data into one or more performance indicators.

The block diagram 400a includes a circuitry 420 configured to generate a mobile application profile for the mobile application using the mobile application data. The circuitry 420 may create a mobile application profile if the application profile does not exist in the profile database. If the profile does exist, the circuitry 420 may update the mobile application profile from time to time based on the mobile application data.

The block diagram 400a includes a circuitry 430 configured to select at least one mobile application to show a mobile advertisement in the at least one mobile application at least partially using the mobile application profile. The circuitry 430 may select at least one mobile application based on the one or more performance indicators. For example, the circuitry 430 may select at least one mobile application based on a performance estimate considering the user ranking in the app stores, the download volume information, and the contextual neutral performance.

The block diagram 400a includes a circuitry 440 configured to obtain user base for each mobile application at least partially based on the mobile application data. The circuitry 440 may obtain mobile application data from the app developers when the app developers request an advertiser to bid on mobile impressions in the mobile app. Thus, the circuitry 440 may have knowledge of each user of the mobile app based on the mobile application data. The circuitry 440 may then obtain user base for the mobile app, where the user base may include most of the mobile users who have installed and used the mobile app.

The block diagram 400a may further include a circuitry 450 configured to generate the mobile application profile at least partially based on the user base. The circuitry 450 may create or modify the mobile application profile to reflect the changes of the user base. For example, the mobile application profile may be updated to reflect the number of active users in the mobile app if the user logs in the mobile app in a preset time period. Similarly, the mobile application profile may be updated to remove a user from the active users when the user does not log in the mobile app for a second preset time period.

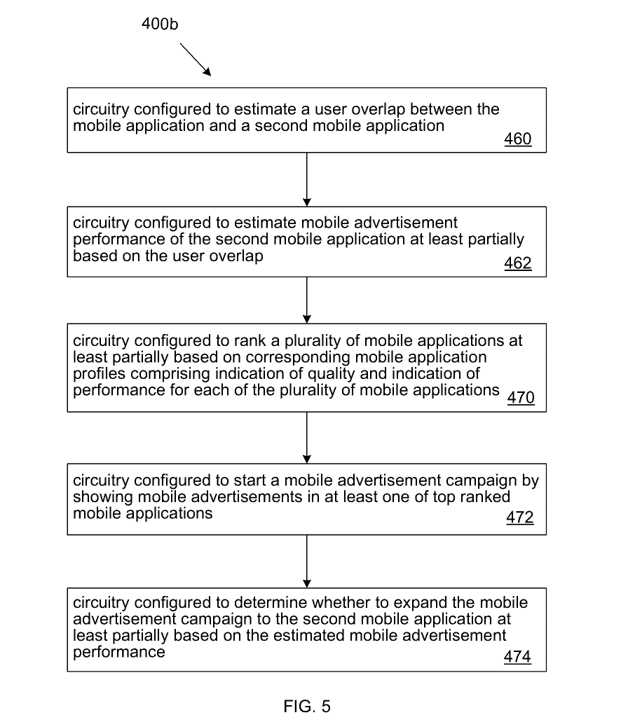

FIG. 5 illustrates embodiments of a block diagram 400b in the server 300 illustrated in FIG. 3. The block diagram 400b may further include a circuitry 460 configured to estimate a user overlap between a first mobile app and a second mobile app. The circuitry 460 may first count the number of common users which uses both the first mobile app and the second mobile app. The circuitry 460 may then obtain the respective percentages of the common users in the first mobile app and in the second mobile app.

The block diagram 400b includes a circuitry 462 configured to estimate mobile advertisement performance of the second mobile application at least partially based on the user overlap. The circuitry 462 may estimate the mobile advertisement performance of the second mobile app using the average performance of common users in the first mobile app. The circuitry 462 may further multiply the average performance with a ratio between the two percentages of common users in the first and second mobile app. For example, the average performance of common users in the first mobile app may have a click through rate (CTR) of R1. The percentage of the number of common users in the first mobile app is P1 and the percentage of the number of common users in the second mobile app is P2. The estimated CTR of the second mobile app may be calculated as R1*P2/P1.

The block diagram 400b includes a circuitry 470 configured to rank a plurality of mobile applications at least partially based on corresponding mobile application profiles including indication of quality and indication of performance for each of the plurality of mobile applications. The circuitry 470 may rank the mobile apps based on history data collected in the last month, or other preset time period. The circuitry 470 may rank the mobile apps based on an averaged performance collected in the last year. The averaged performance may take into account both the indication of quality and indication of performance using the same of different weights. The indication of quality at least partially describes the popularity of the mobile app and the user feedbacks to the mobile app. The indication of performance at least partially describes the performance of the mobile app on contextual neutral advertising. The circuitry 470 may build a model based on historical performance data of each mobile app showing non-contextual relevant ads, where the content of ads is not contextually relevant to the mobile app. For example, an ad about a bank is not contextually relevant to a game app such as Words with Friends.

The block diagram 400b includes a circuitry 472 configured to start a mobile advertisement campaign by showing mobile advertisements in at least one of top ranked mobile applications. The circuitry 472 may start the mobile advertisement campaign in a top ranked mobile app based on historical performance data. The historical performance data may put more weight on performance of contextual neutral advertising. Alternatively or additionally, the advertiser may instruct the circuitry 472 to adjust weights to different performance factors including the indication of quality and the indication of performance described above. The advertisers may request the circuitry 472 to introduce additional performance factor to calculate a customized advertisement performance combining different performance factors.

The block diagram 400b may include a circuitry 474 configured to determine whether to expand the mobile advertisement campaign to the second mobile application at least partially based on the estimated mobile advertisement performance. The circuitry 474 may determine to expand the mobile advertisement campaign to the second mobile with the next highest estimated mobile advertisement performance. Alternatively or additionally, the circuitry 474 may expand the mobile advertisement campaign to the second mobile if the user overlap percentage value is greater than a preset threshold value. For example, if the percentage of the number of common users in the first mobile app is P1 and the percentage of the number of common users in the second mobile app is P2, the circuitry 474 may expand the mobile advertisement campaign to the second mobile if P2/P1 is greater than 50%.

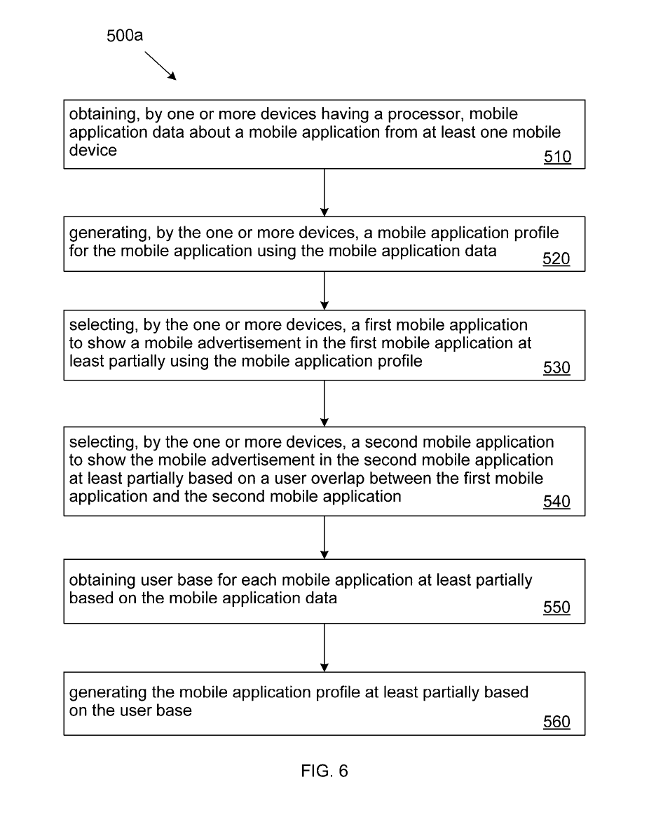

FIG. 6 is an example flow diagram 500a illustrating embodiments of the disclosure. The flow diagram 500a may be implemented at least partially by a computer system that includes a computer server 300 having a processor as illustrated in FIG. 3. The computer implemented method according to the example block diagram 500a includes the following acts. Other acts may be added or substituted.

In act 510, the computer system obtains mobile application data about a mobile application from at least one mobile device. For example, the computer system may obtain mobile application data from a mobile app developer or from a third party data provider. The computer system may obtain mobile user data including device identifications or other types of identifications including IDFA, etc. The computer system may crawl mobile app store information and mobile app social network page and build contextual keyword bag for each mobile app.

In act 520, the computer system generates a mobile application profile for the mobile application using the mobile application data. The computer system may have access to a profile database that stores mobile application profiles for a plurality of mobile apps. The profile database may be updated or modified from time to time based on the mobile application data. The mobile application profile may include: an indication of quality of the mobile application and an indication of performance of the mobile application on contextual neutral advertising. The indication of quality of the mobile application may include indications of popularity of the mobile application and user feedback of the mobile application.

In act 530, the computer system selects a first mobile application to show a mobile advertisement in the first mobile application at least partially using the mobile application profile. The computer system may use the mobile application profile to predict advertising performance for the specific mobile advertisement. The computer system may predict the advertising performance by calculating a customized advertisement performance combining different performance factors.

In act 540, the computer system selects a second mobile application to show the mobile advertisement in the second mobile application at least partially based on a user overlap between the first mobile application and the second mobile application. After the first application is selected and enough data has been collected using the first mobile app, the computer system may further estimate performance of other mobile applications using the user overlap between the first mobile application and the second mobile application.

In act 550, the computer system obtains user base for each mobile application at least partially based on the mobile application data. The computer system may obtain mobile application data from at least one mobile device when the user of the mobile device logs in to the mobile app on the mobile device. Thus, the amount of raw mobile application data is very large and need to be processed near real time by the computer system. The computer system may include cloud-based server system or other servers to collect and process the mobile data. For example, the computer system may update user base of the mobile application when new users log in the mobile app for the first time. The computer system may also divide users to different groups based on the frequency of their interactions with the mobile app.

In act 560, the computer system generates the mobile application profile at least partially based on the user base. The computer system may generate and modify mobile application profiles based on the user base. For example, the computer system may obtain a contextual neutral performance of the mobile app at least partially using the user base. The contextual neutral performance may equals to an average performance lift of contextual neutral advertiser campaign performance on the specific mobile app. The performance lift of an advertiser campaign may be obtain using the following equation.

Performance lift of an advertiser campaign=(advertiser campaign performance on an app−advertiser campaign performance across all contextual neutral app)/advertiser campaign performance across all contextual neutral app

More specifically, the computer system may use the following equations to obtain the performance lift.

$${cnperf}_{app} = \frac{{\sum }_{1}^{n} {lift}_{campaign}}{n}$$

$${lift}_{campaign} = \frac{{perf}_{app} - {perf}_{all context neutral}}{{perf}_{all context neutral}}$$

Here, the term cnperfₐₚₚ is the context neutral performance of an app. The term lift_{campaign} is the performance lift of a campaign. The term perfₐₚₚ is the campaign performance in an app. The term perf_{all context neutral} is the campaign performance across all contextual neutral app. The index n refers to different campaigns on the app.

The estimation of the performance of an app may be biased if the computer system only uses one contextual neutral specific campaign to estimate contextual neutral performance of an app. To resolve this issue of bias, the computer system collects data of multiple experiments. The computer system calculates the performance lift of a large number of contextual neutral campaigns on the specific app. Thus, the variance is reduced with the square root scale of the number of campaigns.

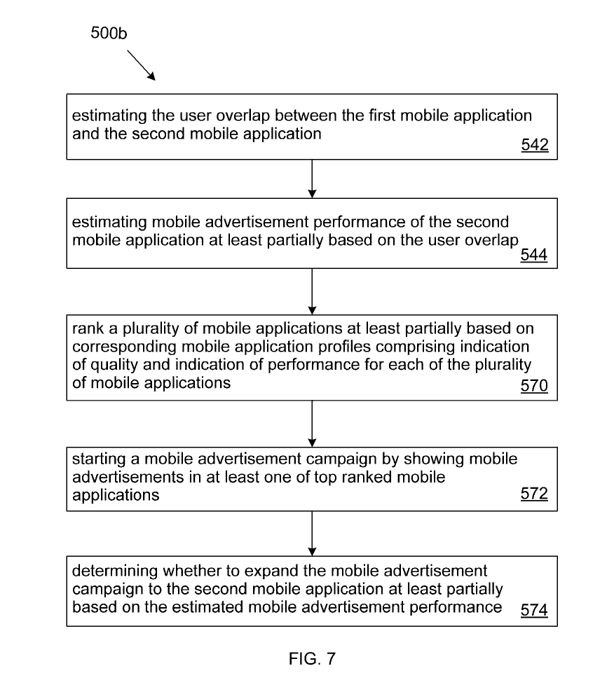

FIG. 7 is an example flow diagram 500b illustrating embodiments of the disclosure. The acts in the example flow diagram 500b may be combined with the acts in the flow diagram 500a shown in FIG. 6. Similarly, the acts in the example flow diagram 500b may be implemented at least partially by a computer system that includes a server computer 300 disclosed in FIG. 3. The computer implemented method according to the example flow diagram 500b includes the following acts. Other acts may be added or substituted.

In act 542, the computer system estimates the user overlap between the first mobile application and the second mobile application. The computer system may the user overlap by measuring the number of common users. Alternatively or additionally, the computer system may estimate the user overlap by measuring the number of common users who also meet certain additional conditions of the advertiser. For example, the computer system may only count common users within a certain age group near a particular geographical location.

In act 544, the computer system estimates mobile advertisement performance of the second mobile application at least partially based on the user overlap. The computer system may estimate the mobile advertisement performance using the user overlap between the first mobile app and the second mobile app as described above. In addition, the computer system may assign different weights to different user groups in the common users so that the estimated mobile advertisement performance may be tuned by a specific advertiser if necessary.

In act 570, the computer system ranks a plurality of mobile applications at least partially based on corresponding mobile application profiles including indication of quality and indication of performance for each of the plurality of mobile applications. The computer system may rank the plurality of mobile apps using multiple performance factors. The performance factors may include: indication of quality, indication of performance, and indication of contextual similarity, and indication of app popularity in a specific demographical range and/or geographical region. The different performance factors may be weighted differently according to inputs from the advertiser. Then the computer system may rank the plurality of mobile apps using a total performance that combines the different performance factors.

In act 572, the computer system starts a mobile advertisement campaign by showing mobile advertisements in at least one of top ranked mobile applications. Once receiving a mobile advertisement campaign from an advertiser, the computer system may immediately start the mobile advertisement campaign in the top ranked mobile app. The computer system may start collecting feedback data from users of the top ranked mobile app and update the app profile.

In act 574, the computer system determines whether to expand the mobile advertisement campaign to the second mobile application at least partially based on the estimated mobile advertisement performance. The computer system may expand the mobile advertisement campaign to the second mobile app using the estimated mobile advertisement performance as described above. Additionally or alternatively, the computer system may expand the mobile advertisement campaign to another app based on the contextual similarities of the first and second apps.

A simplified example is described below to illustrate how the computer system works. An advertiser in the banking industry wants to sell credit cards using mobile ads. The computer system may select a first app G1 to get high lift as a cold start solution.

(1) Every Time someone plays the first app G1, the computer system receives basic user info including an ID for showing ads. The computer system may or may not bid for this user. However, the computer system may associate this ID with the app G1.

(2) Every time someone plays the second app G2, the computer system may use step (1) find IDs of users playing G2.

(3) The computer system thus creates app profiles for both G1 and G2. The app profile may indicate that W, X, Y, Z are users of app G1 and that A, X, Y, Z are users of app G2.

(4) In the beginning, the computer system only targets the first app G1 for the credit cards campaign. After running the campaign for some time, the computer system may determine that users X and Y convert and sign up for a credit card.

(5) Then the computer system may do an analysis of the converted users and find out that both X and Y are also using the second app G2.

(6) Now the compute system may recommend the advertiser to target the second app G2 for the credit cards campaign since there are converters who are common users of both the first app and the second app.

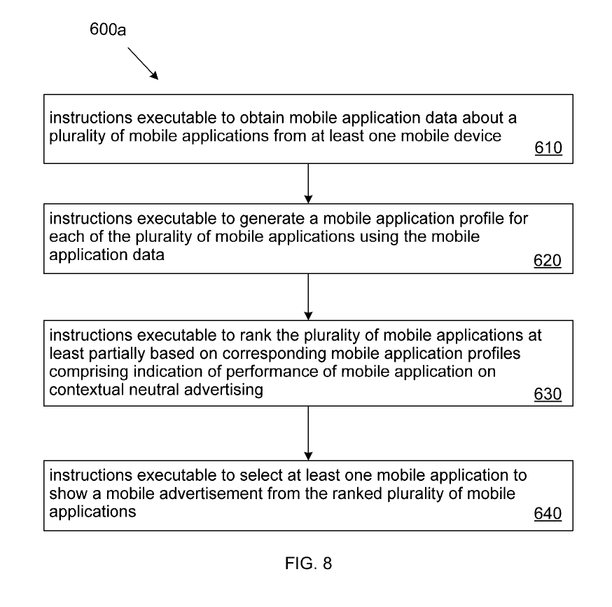

FIG. 8 is an example block diagram illustrating a non-transitory storage medium 600a of the disclosure. The non-transitory storage medium 600a may be programmed to store instructions to be executable by a computer system described above. The non-transitory storage medium 600a may include instructions 610 executable to obtain mobile application data about a plurality of mobile applications from at least one mobile device.

The non-transitory storage medium 600a may include instructions 620 executable to generate a mobile application profile for each of the plurality of mobile applications using the mobile application data. The non-transitory storage medium 600a may include instructions 630 instructions executable to rank the plurality of mobile applications at least partially based on corresponding mobile application profiles comprising indication of performance of mobile application on contextual neutral advertising. The non-transitory storage medium 600a may include instructions 640 instructions executable to select at least one mobile application to show a mobile advertisement from the ranked plurality of mobile applications

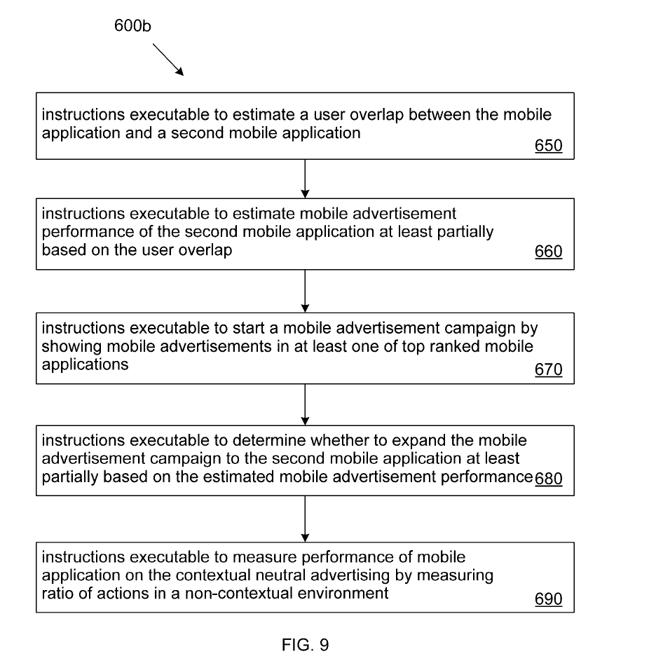

FIG. 9 is an example block diagram illustrating a non-transitory storage medium 600b of the disclosure. The non-transitory storage medium 600b may be combined with the non-transitory storage medium 600a to store instructions to be executable by a computer system described above.

The non-transitory storage medium 600b may include instructions 650 executable to estimate a user overlap between the mobile application and a second mobile application. The computer system may calculate the user base overlap of any new mobile app to clickers or converters of a campaign, even if the new app is not targeted in the campaign right now.

The non-transitory storage medium 600b may include instructions 660 executable to estimate mobile advertisement performance of the second mobile application at least partially based on the user overlap. The instructions 660 may be instruct a server to estimate the mobile advertisement performance based on the number of common users who are performed a desired action defined by the advertiser. For example, the action may include applying for a credit card, clicking the displayed ad, etc.

The non-transitory storage medium 600b may include instructions 670 executable to start a mobile advertisement campaign by showing mobile advertisements in at least one of top ranked mobile applications. The instructions 670 may recommend a few top ranked mobile apps to the advertiser to cold start the mobile ad campaign.

The non-transitory storage medium 600b may include instructions 680 executable to determine whether to expand the mobile advertisement campaign to the second mobile application at least partially based on the estimated mobile advertisement performance.

The non-transitory storage medium 600b may include instructions 690 executable to measure performance of mobile application on the contextual neutral advertising by measuring ratio of actions in a non-contextual environment, wherein the mobile application is not contextually related to the mobile advertisement.

The disclosed computer implemented method may be stored in computer-readable storage medium. The computer-readable storage medium is accessible to at least one hardware processor. The processor is configured to implement the stored instructions to build mobile app profiles, so that the computer system can manage mobile advertisement campaigns without knowing user identity. The computer system collects user base of all mobile app which provides traffic data to the computer system, and get N (e.g. 30 day, 60 day, 90 day, etc.) day aggregated user base set.

From the foregoing, it can be seen that the present embodiments provide a computer system that optimizes mobile campaign without knowing user identity by building a database including mobile app profiles for mobile apps. The computer system provides a solution to measure app quality and ads quality in any app. The computer system further estimates the performance of a second mobile app which is not in the current campaign delivery inventory at least partially using the mobile application profile.

It is therefore intended that the foregoing detailed description be regarded as illustrative rather than limiting, and that it be understood that it is the following claims, including all equivalents, that are intended to define the spirit and scope of this invention.

What is claimed is:

1. A system comprising:
circuitry configured to obtain mobile application data about a mobile application from at least one mobile device;
circuitry configured to generate a mobile application profile for the mobile application using the mobile application data; and
circuitry configured to select at least one mobile application to show a mobile advertisement in the at least one mobile application at least partially using the mobile application profile.

2. The system of claim 1, wherein the mobile application profile comprises: an indication of quality of the mobile application and an indication of performance of the mobile application on contextual neutral advertising.

3. The system of claim 2, wherein the indication of quality of the mobile application comprises indications of popularity of the mobile application and user feedback of the mobile application.

4. The system of claim 2, further comprising:
circuitry configured to obtain user base for each mobile application at least partially based on the mobile application data; and
circuitry configured to generate the mobile application profile at least partially based on the user base.

5. The system of claim 2, further comprising:
circuitry configured to estimate a user overlap between the mobile application and a second mobile application.

6. The system of claim 5, further comprising:
circuitry configured to estimate mobile advertisement performance of the second mobile application at least partially based on the user overlap.

7. The system of claim 6, further comprising circuitry configured to rank a plurality of mobile applications at least partially based on corresponding mobile application profiles comprising indication of quality and indication of performance for each of the plurality of mobile applications.

8. The system of claim 7, further comprising:
circuitry configured to start a mobile advertisement campaign by showing mobile advertisements in at least one of top ranked mobile applications; and
circuitry configured to determine whether to expand the mobile advertisement campaign to the second mobile application at least partially based on the estimated mobile advertisement performance.

9. A method, comprising:
obtaining, by one or more devices having a processor, mobile application data about a mobile application from at least one mobile device;
generating, by the one or more devices, a mobile application profile for the mobile application using the mobile application data;
selecting, by the one or more devices, a first mobile application to show a mobile advertisement in the first mobile application at least partially using the mobile application profile; and
selecting, by the one or more devices, a second mobile application to show the mobile advertisement in the second mobile application at least partially based on a user overlap between the first mobile application and the second mobile application.

10. The method of claim 9, wherein the mobile application profile comprises: an indication of quality of the mobile application and an indication of performance of the mobile application on contextual neutral advertising.

11. The method of claim 10, wherein the indication of quality of the mobile application comprises indications of popularity of the mobile application and user feedback of the mobile application.

12. The method of claim 10, further comprising:
obtaining user base for each mobile application at least partially based on the mobile application data; and
generating the mobile application profile at least partially based on the user base.

13. The method of claim 10, further comprising:
estimating the user overlap between the first mobile application and the second mobile application.

14. The method of claim 13, further comprising:
estimating mobile advertisement performance of the second mobile application at least partially based on the user overlap.

15. The method of claim 14, further comprising:
ranking a plurality of mobile applications at least partially based on corresponding mobile application profiles comprising indication of quality and indication of performance for each of the plurality of mobile applications.

16. The method of claim 15, further comprising:
starting a mobile advertisement campaign by showing mobile advertisements in at least one of top ranked mobile applications; and
determining whether to expand the mobile advertisement campaign to the second mobile application at least partially based on the estimated mobile advertisement performance.

17. A non-transitory storage medium, comprising:
instructions executable to obtain mobile application data about a plurality of mobile applications from at least one mobile device;
instructions executable to generate a mobile application profile for each of the plurality of mobile applications using the mobile application data;
instructions executable to rank the plurality of mobile applications at least partially based on corresponding mobile application profiles comprising indication of performance of mobile application on contextual neutral advertising; and
instructions executable to select at least one mobile application to show a mobile advertisement from the ranked plurality of mobile applications.

18. The non-transitory storage medium of claim 17, further comprising:
instructions executable to estimate a user overlap between the mobile application and a second mobile application; and
instructions executable to estimate mobile advertisement performance of the second mobile application at least partially based on the user overlap.

19. The non-transitory storage medium of claim 18, further comprising:
instructions executable to start a mobile advertisement campaign by showing mobile advertisements in at least one of top ranked mobile applications; and
instructions executable to determine whether to expand the mobile advertisement campaign to the second mobile application at least partially based on the estimated mobile advertisement performance.

20. The non-transitory storage medium of claim 17, further comprising:
instructions executable to measure performance of mobile application on the contextual neutral advertising by measuring ratio of actions in a non-contextual environment, wherein the mobile application is not contextually related to the mobile advertisement.
